(19) United States
(12) Patent Application Publication
(10) Pub. No.: US 2013/0232511 A1
(43) Pub. Date: Sep. 5, 2013

(54) SERVICE RESOLUTION WITHIN DISPARATE PROGRAMMING MODELS

(71) Applicants: Corville O. Allen, Morrisville, NC (US); Pamela H. Fong, Palo Alto, CA (US)

(72) Inventors: Corville O. Allen, Morrisville, NC (US); Pamela H. Fong, Palo Alto, CA (US)

(73) Assignee: International Business Machine Corporation, Amonk, NY (US)

(21) Appl. No.: 13/412,238

(22) Filed: Mar. 5, 2012

(51) Int. Cl. G06F 9/46

(52) U.S. Cl. 719/328

(57) ABSTRACT

Some embodiments include a computer-implemented method for identifying equivalent services. The computer-implemented method can include operations for procuring, by a computer system, a first service description and a second service description, wherein the first and second service descriptions identify characteristics of services available for use by application programs. The computer-implemented method can also include operations for identifying, in the first and second service descriptions, first and second interfaces by which the application programs can call the services, wherein the first and second interfaces define input variables for the service and results returned from the service. The computer-implemented method can also include operations for determining that the first and second interfaces are equivalent, and identifying, in the first and second service descriptions, first and second quality of service types that indicate qualities of service provided by the services.

### BACKGROUND

Embodiments of the inventive subject matter generally relate to the field of software application services, and more particularly to determining whether a plurality of available services are equivalent.

Software developers can use a set of remote services to develop application programs. Typically, software developers utilize services for browser-based application programs. However, these services and other remote based services offer functionalities to build service-oriented applications and web-based application programs, much like traditional application programming interfaces offer functionalities to traditional applications.

In some instances, within a service-oriented application environment, service providers publish their services, including services for public use. The service consumers can query service brokers, service registries or other databases to determine what services are available, and how to call the services. Some web-based applications that utilize services (i.e., service consumers) utilize standardized protocols to access remote services. For example, using standard web protocols such as hypertext transport protocol (HTTP) and extensible markup language (XML), a browser-based application can access services that facilitate credit card processing, inventory control, and any other suitable functionality. These same services can be implemented in different programming models like SCA using a Java Messaging System or HTTP-Post request requests. In the end, these services offer essentially the same results and data when used by a client.

### SUMMARY

Some embodiments include a computer-implemented method for identifying equivalent services. The computer-implemented method can include operations for procuring, by a computer system, a first service description and a second service description, wherein the first and second service descriptions identify characteristics of services available for use by application programs. The computer-implemented method can also include operations for identifying, in the first and second service descriptions, first and second interfaces by which the application programs can call the services, wherein the first and second interfaces define input variables for the service and results returned from the service. The computer-implemented method can also include operations for determining that the first and second interfaces are equivalent; identifying, in the first and second service descriptions, first and second quality of service types that indicate qualities of service provided by the services. The computer-implemented method can also include operations for determining that the first and second quality of service types are equivalent; recording, in a database, information indicating that the first and second interfaces are equivalent, and information indicating that the first and second quality of service types are equivalent, and publishing the database.

Some embodiments include a computer program product for identifying equivalent services, the computer program product including a computer readable storage medium having computer usable program code embodied therewith, the computer usable program code comprising a computer usable program code configured to perform the following operations: procure, by a computer system, a first service description and a second service description, wherein the first and second service descriptions identify characteristics of services available for use by application programs; identify in the first and second service descriptions, first and second interfaces by which the application programs can call the services, wherein the first and second interfaces define input variables for the service and results returned from the service; determine that the first and second interfaces are equivalent; identify, in the first and second service descriptions, first and second quality of service types that indicate qualities of service provided by the services; determine that the first and second quality of service types are equivalent; record, in a database, information indicating that the first and second interfaces are equivalent, and information indicating that the first and second quality of service types are equivalent; and publish the database.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a network in which services are available, according to some embodiments of the inventive subject matter.

FIG. 2 is a flow diagram illustrating operations for identifying equivalent services, according to some embodiments of the inventive subject matter.

FIG. 3 illustrates a portion of a service description file in Open SCA format.

FIG. 4 illustrates a portion of a service description file in Open SCA format.

FIG. 5 is a flow diagram illustrating operations for determining characteristics about services, according to some embodiments of the inventive subject matter.

FIG. 6 is a flow diagram illustrating operations for checking interface compatibility, end points, QOS, and entities as part of a process for determining service equivalence

FIG. 7 depicts an example computer system, according to some embodiments of the inventive subject matter

### DESCRIPTION OF EMBODIMENT(S)

As described above, some application programs utilize services. In some instances, there are multiple services that provide the same or similar functionalities. Some embodiments of the inventive subject matter determine whether two or more services are the same. According to some embodiments, services are the same if they receive the same inputs, and provide the same results. Some embodiments can determine various distinctions between services. For example, two services may receive the same inputs and provide the same results, but the services may have different qualities of service, utilize different end points, and/or different entities may provide the services. Therefore, embodiments help developers choose services that meet specific needs.

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques are omitted for clarity.

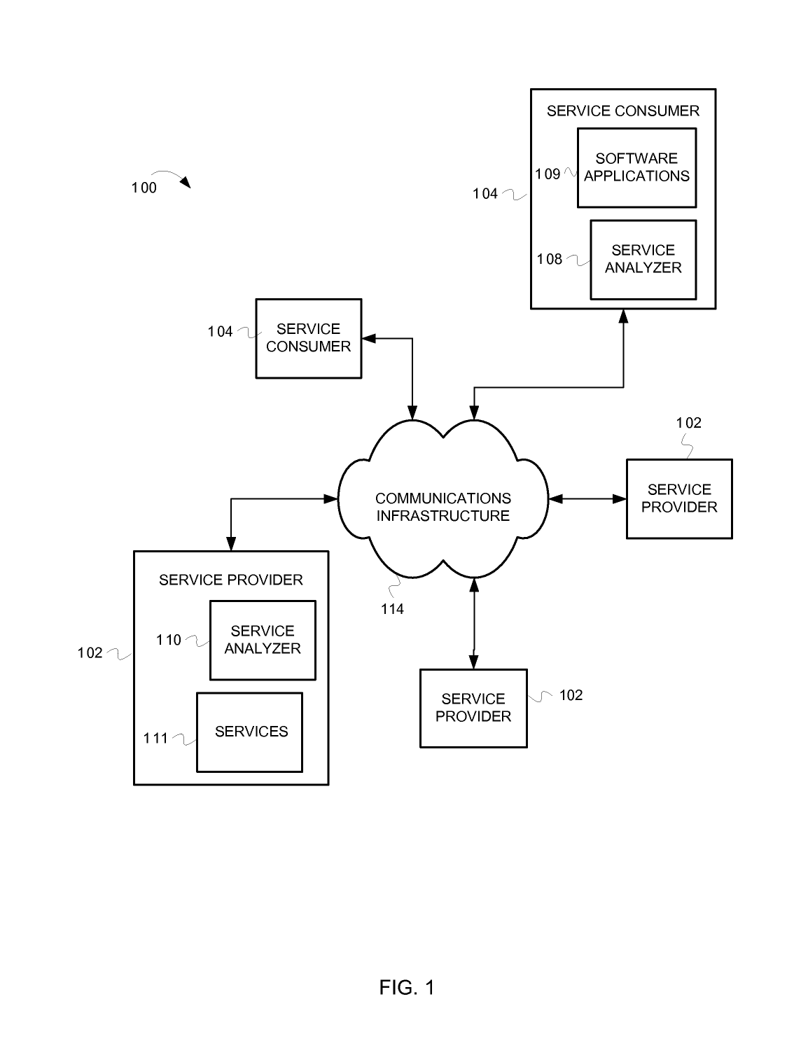

FIG. 1 is a block diagram illustrating a network in which services are available, according to some embodiments of the inventive subject matter. FIG. 1 shows a network 100 including service providers 102 and service consumers 104 connected to a communications infrastructure 114. The service providers 102 and service consumers 104 include computing devices and other components, such as software applications. The service providers 102 offer services 111 for use by software applications 109 running on the service consumers 104. As shown, a service consumer 104 includes a service analyzer 108. In some embodiments, the service analyzer 108 can analyze services offered by remote service providers. For example, the service analyzer 108 may poll service providers to determine available services. After determining what services are available, the service analyzer 108 can determine whether any of the services are equivalent (e.g., whether the services receive the same inputs and provide the same results). Additionally, after determining whether services are equivalent, some embodiments of the service analyzer 108 can determine other differences, such as quality of service, what entity provides the service, from what endpoint service originates, etc.

As shown in FIG. 1, in some embodiments, a service analyzer 110 resides on a service provider 102. The service analyzer 110 can analyze services available on the service provider 102, and identify equivalent services. Additionally, some embodiments of the service analyzer 110 can determine other characteristics of the equivalent services (e.g., the service analyzer 110 can determine quality of service, endpoint at which service originates, etc.). In some embodiments, users (e.g., software application developers) can query the service analyzer 110 for information about equivalent services. As services are added to the service provider, the service analyzer 110 updates a database of equivalent services. Application developers can query (locally or remotely) the database for information about services.

In some embodiments, the service analyzers 108 & 110 identify equivalent services by analyzing files that describe the services. For example, in some embodiments, the service analyzer 110 analyzes Web Services Description Language (WSDL) documents that identify services available on the service provider 102 or other machines. Each service can be associated with a WSDL document. If analysis of the WSDL documents indicates that two or more services receive the same inputs and provide the same outputs, the service analyzer 110 identifies the services as being equivalent. Additional analysis of the WSDL documents can reveal additional similarities and differences between the services. Although some embodiments analyze WSDL documents, other embodiments can analyze any suitable data defining services.

The services can offer any suitable functionality, such as credit card processing functionality, specialized mathematical functionality, document processing functionality, etc. Furthermore, the services can be generated by any suitable development tool and/or programming language (e.g., C++, .NET, C#, etc.). The service consumers can access the services using standard techniques and protocols, such as HTTP, Simple Object Access Protocol (SOAP), Universal Description Discover Integration (UDDI) protocol, etc.

Referring back to FIG. 1, the communications infrastructure 114 can include any suitable devices for transmitting data between the service consumers 104 and service providers 102. For example, communications infrastructure 114 can include components (e.g., switches, routers, bridges, etc.) managed and operated by large-scale telecommunication companies, private businesses, etc.

As shown, embodiments of the service analyzer can reside on service providers and service consumers. In any case, the service analyzer can identify equivalent services. The service analyzer may also identify additional characteristics of equivalent services. The following discussion describes operations for some embodiments of the service analyzer.

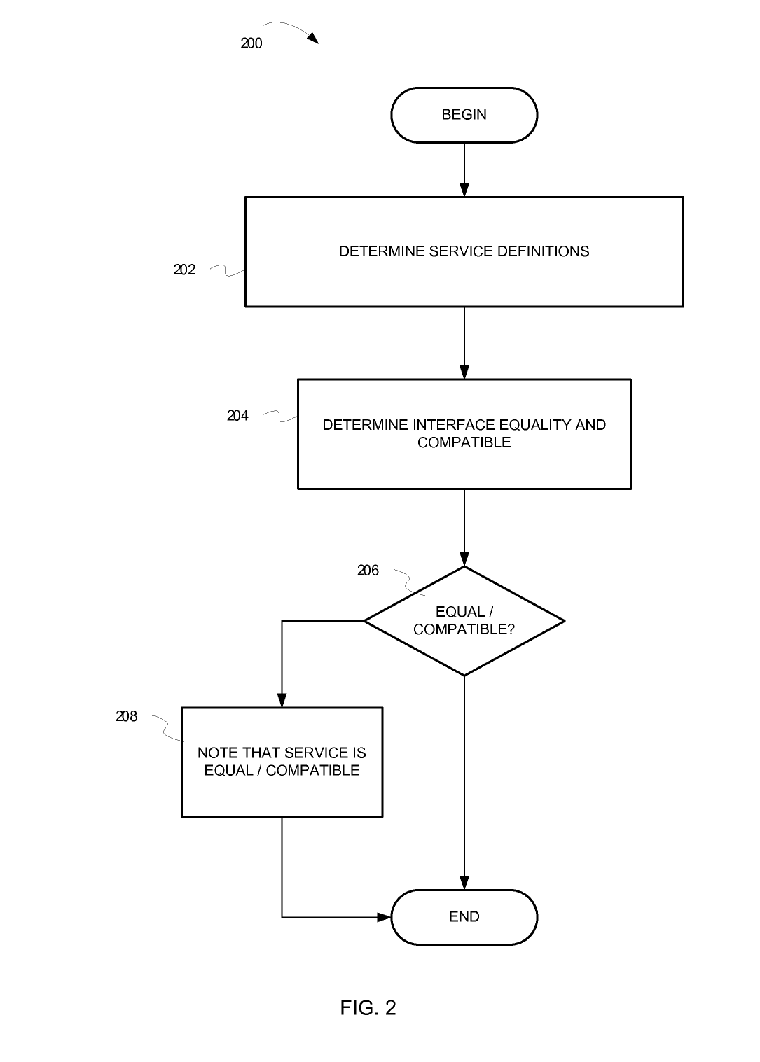

FIG. 2 is a flow diagram illustrating operations for identifying equivalent services, according to some embodiments of the inventive subject matter. In FIG. 2, a flow 200 begins at block 202, where a service analyzer procures service description files associated with two or more services. The services can perform any suitable functionality, such as credit card processing, database lookups, back operations, etc. In some embodiments, the service description files are WSDL documents that include XML markup indicating interfaces for the services. In other instances, the service description files can be represented in Open Service Component Architecture (SCA) format, Classic SCA format, Service Description Language (SCDL), or any other suitable format. In the service description files, interfaces indicate input parameters needed by the services and results returned by the services.

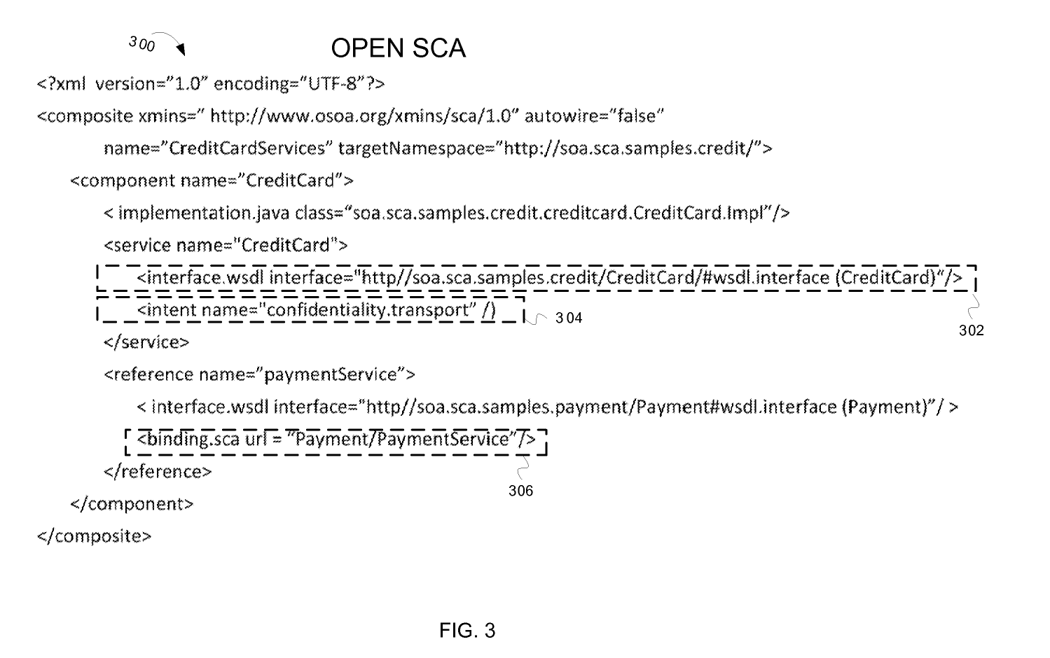

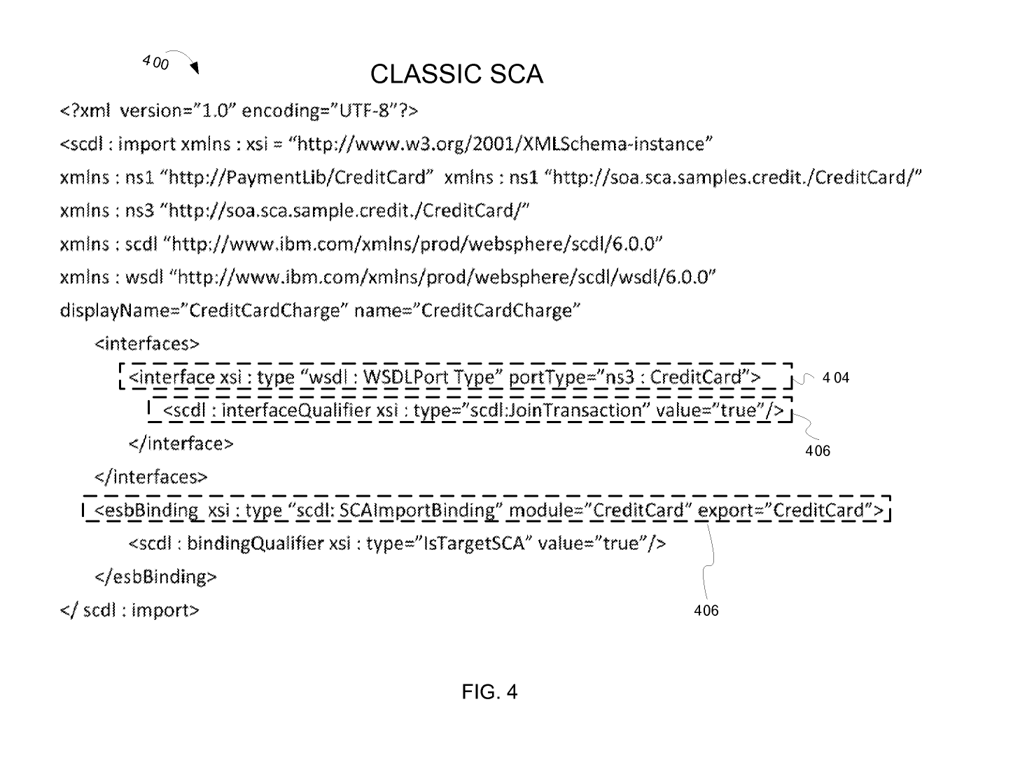

FIGS. 3 and 4 show example service descriptions. FIG. 3 illustrates a portion of a service description file in Open SCA format. FIG. 4 illustrates a portion of a service description file in Open SCA format. Referring back to FIG. 2, the flow continues at block 204.

At block 204, the service analyzer uses the service description files to determine equality of the services' interfaces. That is, using the service description files, the service analyzer determines what parameters the services expect, and what results the services return to consumers. In some embodiments, the inputs parameters and results have assigned data types. Hence, the service analyzer can determine data types of the input parameters and results. In some instances, the service analyzer considers service interfaces as being equal if the interfaces include the same functions, variable names, and data types. In some instances, interfaces are compatible if function names and variable names are similar, and if data types are equivalent. Additionally, interfaces may be compatible if one service includes a subset of another service's functionality (e.g., functions, methods, procedures, etc.), where variable names and data types match for the matching functionality.

In embodiments in which the service description is represented in a WSDL document, the service analyzer parses the WSDL's XML code to determine the service's inputs and outputs. The service analyzer can search the XML code for tags that indicate the service's input parameters and results. Many WSDL documents include XML tags indicating “messages”, “portTypes”, and “operations”. In WSDL, portTypes define groups of operations performed by a service, where each operation receives inputs and provides outputs. In WSDL documents, the operations (defined in the portTypes) typically include tags indicating the operations' “inputs” and “outputs”. That is, XML tags indicate the operation's input parameters and results. In some embodiments, if two WSDL documents have one or more matching portTypes, the service interfaces are equal. In some embodiments, portTypes match if they include operations, inputs, and outputs having the same names and data types. In other embodiments, portTypes are compatible if they have similar names and the same data types.

As noted, in some embodiments, the service description is represented using WSDL. WSDL has changed over time. Thus, while some of the examples described herein refer to particular WSDL tags and formats, embodiments of the inventive subject matter are flexible, and will support different versions and flavors of WSDL versions. In contrast, some embodiments represent service descriptions using other formats, such as service component definition language (SCDL), web application description language (WADL), etc.

In FIG. 3, the Open SCA service description 300 includes an XML statement 302 indicating an interface for a service associated with the service description 300. In FIG. 4, the Classic SCA service description includes an XML statement 404 indicating an interface for a service associated with the service description 400.

Referring back to FIG. 2, the flow continues at block 206.

At block 206, if the service interfaces are equivalent or compatible, the flow continues at block 208, where the service analyzer records an indication that two or more services are equal or compatible. If the service interfaces are not equal and not compatible, the flow ends. After the service analyzer completes the flow 200, it can publish the information resulting from the flow 200. For example, the service analyzer can insert, into a database, information indicating that two services are equivalent, and make the database publicly available (e.g., at a web address).

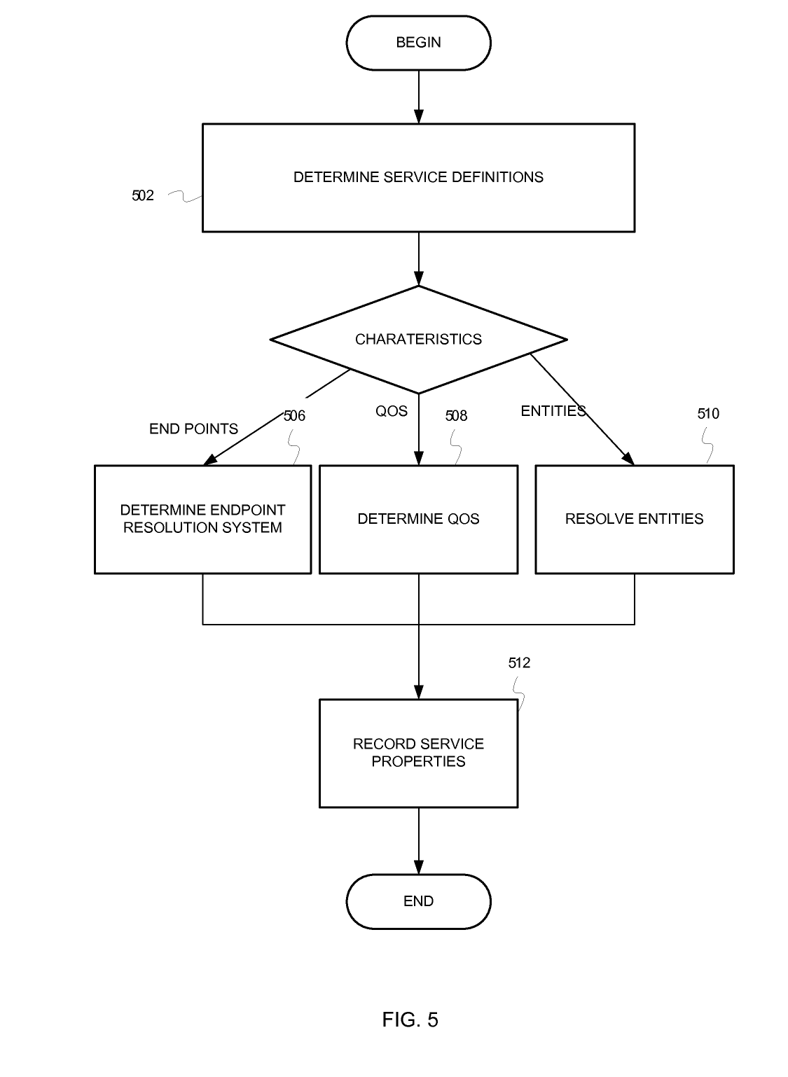

In some embodiments, the service analyzer executes the flow in FIG. 2 for all available services. Therefore, the service analyzer creates a database of equivalent services. Software developers can consult the database of equivalent services when selecting services for application programs. Such a database may be located on a service provider, service consumer, or other available component. In addition to determining interface equality/compatibility, some embodiments can determine other characteristics about the services. For example, some embodiments can determine qualities of service for the services, endpoints at which the services are provided, and entities that provide the services. FIG. 5 describes operations for determining such characteristics.

FIG. 5 is a flow diagram illustrating operations for determining characteristics about services, according to some embodiments of the inventive subject matter. In FIG. 5, a flow 500 begins at block 502, where a service analyzer procures service descriptions. In some embodiments, the service descriptions are represented as WSDL documents, SCDL documents, Open SCA documents, Classic SCA documents, other suitable machine-readable files. The flow continues at block 504.

After procuring the service descriptions, the service analyzer parses the service descriptions to determine characteristics of the services. For the embodiment shown in FIG. 5, the service analyzer can determine end points at which the services offered (at block 506), a quality of service associated with the service (at block 508), and an entity that provides the service (at block 510). In some embodiments the service analyzer determines all three characteristics, while in other embodiments the service analyzer determines one or two of the characteristics. In yet other embodiments, the service analyzer can determine other characteristics, based on the service descriptions, such as fault operations defined by the service, etc.

At block 506, the service analyzer determines an endpoint at which service is performed. That is, the service analyzer determines a web address (e.g., a uniform resource locator) at which the services are performed. For embodiments in which the service descriptions are represented as WSDL documents, the service analyzer can parse the WSDL document's XML code to determine an endpoint for the service. For example, the service analyzer can search the WSDL document for an XML “port” tag, which indicates an address or connection point to the service (e.g., an HTTP URL string). In some versions of WSDL, endpoints identified by XML “endpoint” tags.

At block 508, the service analyzer determines a quality of service (QOS) types associated with the service. For example, application developers may need data to be stored persistently to avoid data loss, if the service fails. In some instances, qualities of service are implicitly indicated in service descriptions. For example, Java Messaging Service (JMS) and IBM's MQ Series persistently stores data, whereas other protocols do not persistently store data (Enterprise Information System). The service analyzer examines the service description to determine various (explicit or implicit) qualities of service, such as whether protocols are persistent, asynchronous, synchronous, etc. In some embodiments, qualities of service are equivalent if they are both services use persistent protocols. If the service description is represented in a WSDL document, the document may include an XML “binding” tag that indicates JMS or some other persistent protocols. For the Open SCA service description in FIG. 3, the XML tag 304 indicates an “intent” for the service, where the intent indicates a QOS. For the Classic SCA service description in FIG. 4, the XML tag 406 indicates an “interfaceQualifier” that indicates a QOS.

Qualities of service can include: 1) Transactional QOS—for transaction QOS, if all operations associated with a transaction do not successfully complete, the whole transaction fails. 2) Global Transactional QOS—a plurality of transactions must complete successfully or all the transactions will fail. 3) Confidentially QOS—different aspects of confidentiality may be applied to a service's data, such as transport layer confidentiality (e.g., encrypted at the transport layer), message confidentiality (e.g., a message itself is encrypted, so HTTPS is not needed for security), etc. Some embodiments can normalize qualities of service types to a basic type. This way, the service analyzer can identify services as equivalent despite insignificant differences in QOS. For example, two service descriptions may indicate different Confidentiality QOS types, such as message confidentiality versus transport layer confidentiality. The service analyzer may normalize these different QOS types to a single type, such as “secure QOS”. Users can configure normalization by configuring normalization parameters in the service analyzer.

At block 510, the service analyzer determines whether two or more services are provided by the same entity. In some embodiments, the service analyzer makes this determination based on test data. The service analyzer can provide test data to the services and comparing results received from the services. In some instances, application developers define test data that the service analyzer will send to the services. If the service analyzer sends the same test data to different services and receives the same results from those services, the entities are equal. Otherwise, the entities are different.

As noted above, embodiments may perform one or more of endpoint resolution, quality of service resolution, entity resolution (see blocks 506, 508, 510). After performing one or more of these operations, the flow continues at block 512. At block 512, the service analyzer records results discovered during the operations. For example, the service analyzer records information indicating that two more service are offered at the same endpoint. From block 512, the flow ends.

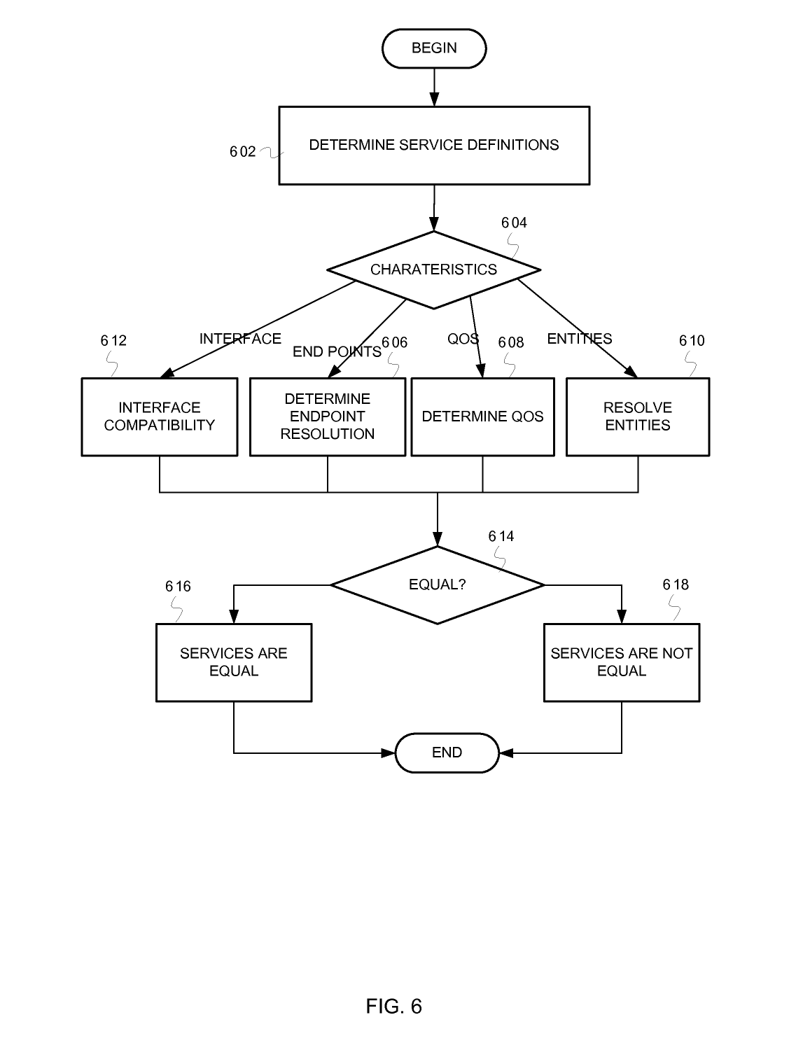

In some embodiments, a service analyzer can check interface compatibility, end points, QOS, and entities as part of a process for determining service equivalence. FIG. 6 shows such as process. In FIG. 6, if the service descriptions have matching interfaces, QOS, entities, and end points, the services are equivalent. Otherwise, the services are not equivalent. In some embodiments, the flow in FIG. 6 can consider QOS normalization as part of determining whether quality of service types match.

As yet another example, the following text represents a WSDL service description:

```
<?xml version=“1.0” encoding=“UTF-8”?><wsdl:definitions
name=“CreditCard”
targetNamespace=“http://soa.sca.sample.credit/CreditCard/”
xmlns:soap=“http://schemas.xmlsoap.org/wsdl/soap/”
xmlns:tns=“http://soa.sca.sample.credit/CreditCard/”
xmlns:wsdl=“http://schemas.xmlsoap.org/wsdl/”
xmlns:xsd=“http://www.w3.org/2001/XMLSchema”>
  <wsdl:types>
    <xsd:schema targetNamespace=“http://soa.sca.sample.credit/
    CreditCard/”
xmlns:Q1=“http://soa.sca.sample.credit/Charge”>
            <xsd:import schemaLocation=“Charge.xsd”
namespace=“http://soa.sca.sample.credit/Charge”></xsd:import>
            <xsd:element name=“chargeIt”>
        <xsd:complexType>
          <xsd:sequence>
            <xsd:element name=“charge” type=“Q1:ChargeType” />
          </xsd:sequence>
        </xsd:complexType>
      </xsd:element>
      <xsd:element name=“chargeItResponse”>
        <xsd:complexType>
          <xsd:sequence>
            <xsd:element name=“out” type=“xsd:boolean”/>
          </xsd:sequence>
        </xsd:complexType>
      </xsd:element>
    </xsd:schema>
  </wsdl:types>
  <wsdl:message name=“chargeItRequest”>
    <wsdl:part element=“tns:chargeIt” name=“parameters”/>
  </wsdl:message>
  <wsdl:message name=“chargeItResponse”>
    <wsdl:part element=“tns:chargeItResponse” name=“parameters”/>
  </wsdl:message>
  <wsdl:portType name=“CreditCard”>
    <wsdl:operation name=“chargeIt”>
      <wsdl:input message=“tns:chargeItRequest”/>
      <wsdl:output message=“tns:chargeItResponse”/>
    </wsdl:operation>
  </wsdl:portType>
  <wsdl:binding name=“CreditCardSOAP” type=“tns:CreditCard”>
            <soap:binding style=“document”
                transport=“http://schemas.xmlsoap.org/soap/http” />
            <wsdl:operation name=“chargeIt”>
                <soap:operation
                    soapAction=“http://soa.sca.sample.credit/
                    CreditCard/chargeIt” />
                <wsdl:input>
                    <soap:body use=“literal” />
                </wsdl:input>
                <wsdl:output>
                    <soap:body use=“literal” />
                </wsdl:output>
            </wsdl:operation>
  </wsdl:binding>
  <wsdl:service name=“CreditCard”>
    <wsdl:port binding=“tns:CreditCardSOAP”
    name=“CreditCardSOAP”>
      <soap:address location=“http://www.example.org/”/>
    </wsdl:port>
  </wsdl:service>
</wsdl:definitions>
```

As described above, embodiments of the service analyzer can compare various characteristics between services. In some embodiments, users can configure the service analyzer to consider any combination of characteristics (e.g., interfaces, entities, endpoints, quality of service, etc.) when determining whether two or more services are equivalent. For example, an application developer can configure the service analyzer to indicate that two services are equivalent if their interfaces are equivalent. As another example, and application developer can configure the service analyzer to indicate that services are equivalent if the services' interfaces are equivalent, and they have the same qualities of service. Therefore, in some embodiments, the service analyzer indicates that services are “equivalent” even though all characteristics are not identical. Although not shown, embodiments of the service analyzer present users with a configuration interface that enables the users to select configuration settings. For example, the service analyzer can receive user input indicating which characteristics (e.g., interfaces, qualities of service, etc.) to evaluate when determining whether services are equivalent. In some embodiments, the service analyzer receives specific information about each property, such as information indicating which qualities of service are considered equivalent, whether compatible interfaces are considered equivalent, etc. The service analyzer can also receive user input indicating test data for use in entity resolution. Because the service analyzer is configurable, it can identify services that conform to specific needs.

As discussed herein, aspects of the present inventive subject matter are described with reference to flowcharts and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In some embodiments, the operations described herein may be represented by instructions stored in a computer readable medium or a plurality of computer readable mediums. A computer readable medium includes a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

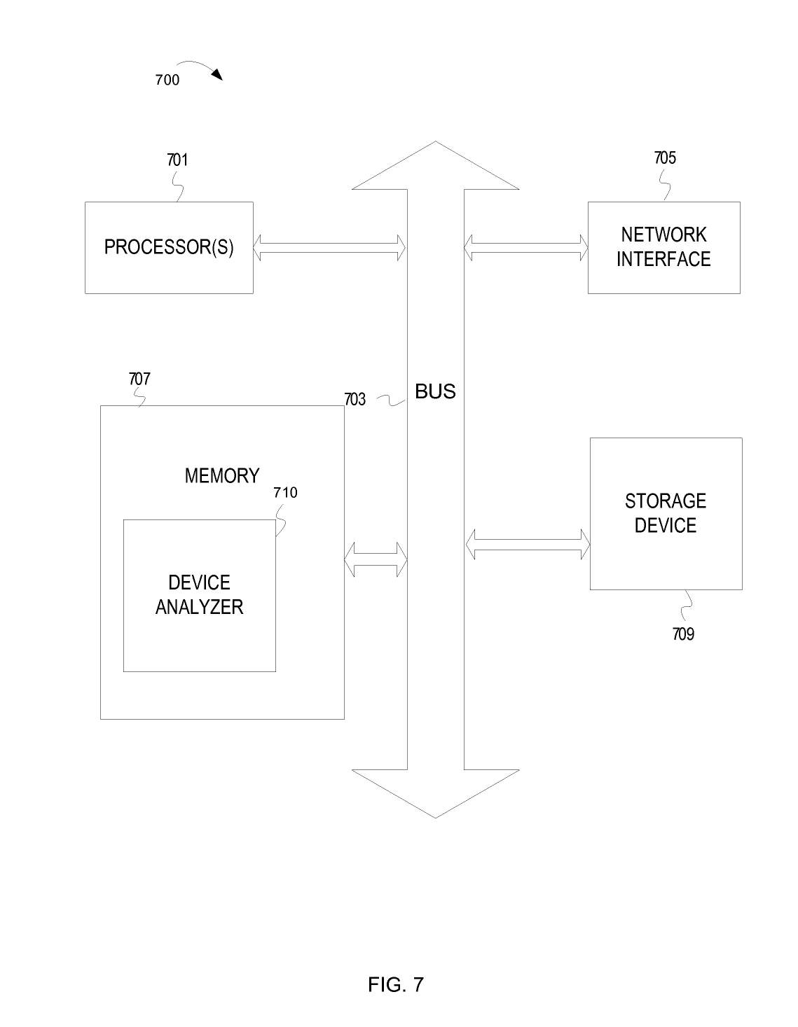

FIG. 7 depicts an example computer system, according to some embodiments of the inventive subject matter. A computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 includes a device analyzer 710. The device analyzer 710 can perform the operations described vis-à-vis FIGS. 2 and 3. Any one of these operations may be partially (or entirely) implemented in hardware and/or on the processing unit 701. For example, the operations may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

While the embodiments are described with reference to various implementations and exploitations, it will be understood that these embodiments are illustrative and that the scope of the inventive subject matter is not limited to them. In general, techniques for determining equivalent web services as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method for identifying equivalent services, the computer implemented method comprising:
procuring, by a computer system, a first service description and a second service description, wherein the first and second service descriptions identify characteristics of services available for use by application programs;
identifying, in the first and second service descriptions, first and second interfaces by which the application programs can call the services, wherein the first and second interfaces define input variables for the service and results returned from the service;
determining that the first and second interfaces are equivalent;
identifying, in the first and second service descriptions, first and second quality of service types that indicate qualities of service provided by the services;
determining that the first and second quality of service types are equivalent;
recording, in a database, information indicating that the first and second interfaces are equivalent, and information indicating that the first and second quality of service types are equivalent; and
publishing the database.

2. The computer-implemented method of claim 1, wherein the first and second service definitions are represented in Web Service Description Language (WSDL) documents, and wherein the first and second interfaces are identified by extensible markup language (XML) tags.

3. The computer-implemented method of claim 1, wherein the first and second service descriptions are represented in Service Component Description Language (SCDL) documents, and wherein the first and second interfaces are identified by extensible markup language (XML) tags.

4. The computer-implemented method of claim 1 further comprising:
identifying, in the first and second service descriptions, first and second network addresses at which the services are performed;
determining that the first and second network addresses are the same recording information indicating that the services are performed at the same network address.

5. The computer-implemented method of claim 1, where in the determining that the first and second quality of service types are equivalent comprises:
identifying, in the first and second service descriptions, one or more policy-based quality intents and property-based quality descriptions.

6. The computer-implemented method of claim 1 where in the determining that the first and second quality of service types are equivalent comprises:
identifying extensible markup language (XML) tags indicating the quality of service types;
normalizing the qualities of service to one or more basic quality of service types; and
determining that the one or more basic quality of service types are equivalent.

7. The computer-implemented method of claim 1, wherein the first and second service descriptions are represented in SCDL, wherein the determining the first and second quality of service types includes:
identifying extensible markup language (XML) identifiers in the first and second service descriptions, wherein the XML identifiers represent binding types in the first and second service descriptions; and
normalizing the quality of service types to one or more basic quality of service types.

8. The computer-implemented method in claim 1, further comprising:
receiving configuration data that define equivalence for the first and second service.

9. A computer program product for identifying equivalent services, the computer program product comprising:
a computer readable storage medium having computer usable program code embodied therewith, the computer usable program code comprising a computer usable program code configured to:
procure, by a computer system, a first service description and a second service description, wherein the first and second service descriptions identify characteristics of services available for use by application programs;
identify in the first and second service descriptions, first and second interfaces by which the application programs can call the services, wherein the first and second interfaces define input variables for the service and results returned from the service;
determine that the first and second interfaces are equivalent;
identify, in the first and second service descriptions, first and second quality of service types that indicate qualities of service provided by the services;
determine that the first and second quality of service types are equivalent;
record, in a database, information indicating that the first and second interfaces are equivalent, and information indicating that the first and second quality of service types are equivalent; and
publish the database.

10. The computer program product of claim 9, wherein the first and second service definitions are represented in Web Service Description Language (WSDL) documents, and wherein the first and second interfaces are identified by extensible markup language (XML) tags.

11. The computer program product of claim 9, wherein the first and second service descriptions are represented in Service Component Description Language (SCDL) documents, and wherein the first and second interfaces are identified by extensible markup language (XML) tags.

12. The computer program product of claim 9, the computer usable program code further configured to:
identify, in the first and second service descriptions, first and second network addresses at which the services are performed;
determine that the first and second network addresses are the same record information indicating that the services are performed at the same network address.

13. The computer program product of claim 9, where in the computer usable program code configured to determine that the first and second quality of service types are equivalent comprises program code configured to:
identify, in the first and second service descriptions, one or more policy-based quality intents and property-based quality descriptions.

14. The computer program product of claim 9, wherein the computer usable program code configured to determine that the first and second quality of service types are equivalent comprises program code configured to:
identify extensible markup language (XML) tags indicating the quality of service types;
normalize the qualities of service to one or more basic quality of service types; and
determine that the one or more basic quality of service types are equivalent.

15. The computer program product of claim 9, wherein the first and second service descriptions are represented in SCDL, wherein the computer usable program code configured to determine the first and second quality of service types includes program code configured to:
identify extensible markup language (XML) identifiers in the first and second service descriptions, wherein the XML identifiers represent binding types in the first and second service descriptions; and
normalize the quality of service types to one or more basic quality of service types.

16. The computer program product of claim 9, the computer usable program code further configured to:
receive configuration data that defines equivalence for the first and second services.

17. An apparatus comprising:
a processor configured to execute instructions for a service analyzer;
the service analyzer configured to
procure, by a computer system, a first service description and a second service description, wherein the first and second service descriptions identify characteristics of services available for use by application programs;
identify in the first and second service descriptions, first and second interfaces by which the application programs can call the services, wherein the first and second interfaces define input variables for the service and results returned from the service;
determine that the first and second interfaces are equivalent;
identify, in the first and second service descriptions, first and second quality of service types that indicate qualities of service provided by the services;
determine that the first and second quality of service types are equivalent;
record, in a database, information indicating that the first and second interfaces are equivalent, and information indicating that the first and second quality of service types are equivalent; and
publish the database.

18. The apparatus of claim 17, wherein the first and second service definitions are represented in Web Service Description Language (WSDL) documents, and wherein the first and second interfaces are identified by extensible markup language (XML) tags.

19. The apparatus of claim 17, wherein the first and second service descriptions are represented in Service Component Description Language (SCDL) documents, and wherein the first and second interfaces are identified by extensible markup language (XML) tags.

20. The apparatus of claim 17, wherein the service analyzer is further configured to:
receive configuration data defining equivalence for the first and second services.
